(19) United States
(12) Patent Application Publication
(10) Pub. No.: US 2010/0288567 A1
(43) Pub. Date: Nov. 18, 2010

(54) MOTOR VEHICLE WITH A TOUCHPAD IN THE STEERING WHEEL AND METHOD FOR ACTUATING THE TOUCHPAD

(75) Inventor: Uwe BONNE, Kriftel (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/774,625

(22) Filed: May 5, 2010

(30) Foreign Application Priority Data
May 14, 2009 (DE) 102009021280.9

(51) Int. Cl. G06F 3/041

(52) U.S. Cl. 178/18.01

(57) ABSTRACT

A motor vehicle is equipped with a steering wheel to which is allocated a touchpad for controlling various functions of the motor vehicle. A touchpad can be automatically deactivated when the steering wheel exceeds a prescribed angle of lock. Also indicated is a corresponding method for actuating the touchpad.

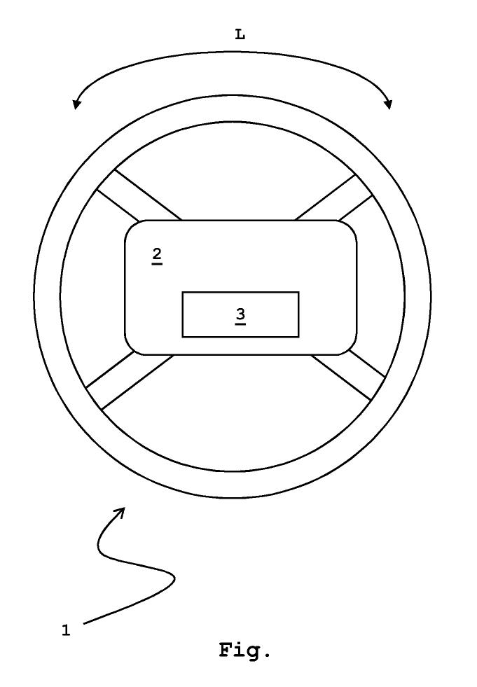

### CROSS-REFERENCE TO RELATED APPLICATION

This application claims priority to German Patent Application No. 102009021280.9, filed May 14, 2009, which is incorporated herein by reference in its entirety.

### TECHNICAL FIELD

The invention relates to a motor vehicle with a steering wheel, which has allocated to it a touchpad for controlling various functions of the motor vehicle, and a method for actuating the touchpad.

### BACKGROUND

In motor vehicles, a driver can influence various functions, for example an audio system, an air conditioning system or rear mirror setting, using different control elements. To simplify operation, it is known to actuate the various functions of the motor vehicle using essentially a single control element, wherein the actuating element is for this purpose used to implement menu-guided control sequence, the respective possible selections are shown on a display, such as an LCD screen.

Known from DE 200 20 227 U1 in order not to have to take your hands off the steering wheel for actuating various functions is to equip the steering wheel with a touch-sensitive sensor surface that when touched generates an electronic signal to actuate any desired vehicle functions. As a result, a driver can retain full control over the motor vehicle even when operating various functions.

DE 10 2006 024 252 A1 also discloses a control system for a vehicle cockpit, wherein various functions of the motor vehicle can be actuated via finger movements on a touch-sensitive exterior steering wheel surface.

Such touchpads are also used in notebooks or laptops, wherein movements by the pointer finger, for example, are usually acquired by means of electrical capacitors. The known touchpads integrated into the steering wheel of a motor vehicle are disadvantageous to the extent that an undesired control command is entered as the result of carelessness or ill-considered hand movements.

At least one object of the invention is to develop a motor vehicle of the kind mentioned at the outset that effectively prevents the driver from being unintentionally distracted by an inadvertent actuation of a vehicle function. In addition, a corresponding method for actuating a touchpad is to be indicated. Furthermore, other objects, desirable features, and characteristics will become apparent from the subsequent summary and detailed description, and the appended claims, taken in conjunction with the accompanying drawings and this background.

### SUMMARY

The at least one object, other objects, desirable features and characteristics, are achieved in a motor vehicle by virtue of the fact that the touchpad can be automatically deactivated when the steering wheel exceeds a prescribed angle of lock, and in the method by virtue of the fact that the touchpad is automatically deactivated when the steering wheel exceeds a prescribed angle of lock.

For example, the steering wheel of the motor vehicle exhibits a known touchpad so as to actuate various functions of the motor vehicle. The touchpad does not have to be spatially, but only functionally allocated to the steering wheel in terms of the invention, for example by way of a control coupling with a angle of lock sensor or some other component that acquires the angle of lock. Within the framework of the invention, the term touchpad is to be understood as only a touch-sensitive surface, wherein a touch or brush of a fingertip, for example, makes it possible to select various functions of a menu-guided controller, and then select and/or activate the functions by pressing harder or repeatedly on the touch-sensitive surface. Also to be understood by the term touchpad is a touch-sensitive screen, such as an LCD display, in which the selection menu is displayed on the screen surface, and the respective function or a menu level can be selected by touching and/or pressing with the fingertip.

However, if the steering wheel is turned too sharply during the normal driving operation of the motor vehicle, for example by more than approximately 30 degrees to one side, the touchpad is practically impossible to properly operate any longer, since a finger can no longer move in the proper direction on the touchpad, for example up or down. This is why the touchpad is automatically deactivated if the steering wheel exceeds the prescribed angle of lock. Correspondingly, correct entries or actuations via the touchpad are essentially only possible while the motor vehicle is traveling straight ahead. As a result, the driver is not distracted from operation by changes in direction by the motor vehicle. In principle, the user can individually set the angle of lock of the steering wheel at which the touchpad is automatically deactivated if the user still wishes to operate the touchpad when traveling on gently curving roads.

At least one advantage lies in the fact that only components already present in the motor vehicle, such as the touchpad allocated to the steering wheel and a central controller and an angle of lock sensor need to be correspondingly actuated. Once the controller has determined that the steering wheel has exceeded a limit for the angle of lock, the touchpad is automatically deactivated. This effectively precludes inadvertent operations or malfunctions, for example in the process of parking, resulting from the unintended touching of the touchpad during a sharp steering motion. The corresponding functionality can be easily implemented in the controller.

The touchpad need not be directly arranged on the steering wheel, for example on the central steering wheel pot; rather, the touchpad can also be ergonomically situated within easy reach, for example in the area of a hand brake lever on a central console or a dashboard, so that the touchpad can be accessed without any major retraction motions. In this case, a touchpad, for example arranged on the central console, is also deactivated if the steering wheel exceeds a prescribed angle of lock so as to prevent any unintended faulty operations.

After a certain, especially adjustable, duration, the touchpad is automatically deactivated. If no entry is made via the touchpad over a prolonged period, for example approximately 30 seconds, the controller can surmise that the driver currently does not desire any changes in the driving status, or relative to motor vehicle functions. Correspondingly, the touchpad is deactivated to avert an unintended incorrect operation.

The touchpad can expediently be actuated by the user or driver him/herself. For example, this can be done by holding down or repeatedly pressing a specific sensor surface. In this way, the driver can him/herself determine whether and when he/she wishes to make a control input by way of the touchpad.

In a further development, the touchpad is configured in such a way that the touch sensitivity with which entries or control are accepted can be adjusted as a function of a driving status of the motor vehicle. For example, in dangerous situations detectable by an abrupt pressing of the brake pedal, the touch sensitivity can be set in such a way that only a strong actuation of the touchpad triggers a control command.

Of course, the features mentioned above and yet to be described below can be used not just in the respectively indicated combination, but also in other combinations.

### BRIEF DESCRIPTION OF THE DRAWING

The present invention will hereinafter be described in conjunction with the following drawing figure showing a steering wheel of a motor vehicle according to an embodiment of the invention in diagrammatic form.

### DETAILED DESCRIPTION

The following detailed description is merely exemplary in nature and is not intended to limit application and uses. Furthermore, there is no intention to be bound by any theory presented in the preceding background or summary or the following detailed description.

A touch-sensitive touchpad 3 is arranged on a steering wheel pot 2 of the steering wheel 1 for controlling the motor vehicle. For example, by touching or brushing over the touchpad 3, various functions of the motor vehicle can be selected and actuated by way of a menu-guided controller. The touch of a touchpad 3 is usually detected in a capacitive manner.

The touchpad 3 is actuated in such a way as to be automatically deactivated while turning steering wheel as denoted by the double arrow L once the steering wheel has exceeded a limit for the angle of lock. For example, deactivation can be initiated by a controller that receives signals from a steering wheel angle of lock sensor. Of course, the touchpad 3 is automatically activated again when the steering wheel 1 is turned back into a neutral position if the angle of lock of the steering wheel drops below the limit.

In principle, the touchpad 3 can also be activated or deactivated by the user him/herself, or turns off automatically after a preferably adjustable period. The touch sensitivity of the touchpad 3 can also be changed as a function of driving state, for example depending on outside conditions. For example, touch sensitivity is reduced during a strong rain or limited visibility due to fog, so that a control command can only be implemented by strongly actuating or pressing the touchpad 3.

The touchpad 3 is designed either as just a touch-sensitive surface, or as a touch-sensitive screen.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
a steering wheel; and
a touchpad allocated to the steering wheel and adapted to control a function of the motor vehicle, wherein the touchpad is adapted to deactivate once the steering wheel has exceeded a preset angle of lock.

2. The motor vehicle of claim 1, wherein the touchpad is deactivated after a predetermined duration.

3. The motor vehicle of claim 1, wherein the touchpad is deactivated after an adjustable duration.

4. The motor vehicle of claim 1, wherein the touchpad is adapted for activation by a user.

5. The motor vehicle of claim 1, wherein the touchpad is adapted for deactivation by a user.

6. The motor vehicle of claim 1, wherein a sensitivity of the touchpad can be varied as a function of a driving state.

7. A method for actuating a touchpad adapted to control a various function of a motor vehicle that is allocated to a steering wheel of the motor vehicle, comprising the steps of:
determining an angle of the steering wheel; and
deactivating the touchpad when the angle of the steering wheel exceeds a prescribed angle of stop.

8. The method of claim 7, wherein the step of deactivating comprises determining a duration and deactivating the touchpad after the duration.

9. The method of claim 8, wherein the duration is adjustable.

10. The method of claim 7, further comprising the step of receiving an activation command for the touchpad.

11. The method of claim 7, further comprising the step of receiving a deactivation command.

12. The method of claim 7, further comprising the step of varying a sensitivity of the touchpad as a function of a driving state.
